(19) United States
(12) Patent Application Publication
(10) Pub. No.: US 2017/0193240 A1
(43) Pub. Date: Jul. 6, 2017

(54) AUTHORIZED DATA SOURCE VALIDATION OF EVIDENCE TOOL

(71) Applicant: BANK OF AMERICA CORPORATION, Charlotte, NC (US)

(72) Inventors: Maria Jacquelyn Smith Baker, Fort Mill, SC (US); Jay Russell Smart, Concord, NC (US); David John Perro, Denver, NC (US)

(21) Appl. No.: 14/986,815

(22) Filed: Jan. 4, 2016

(51) Int. Cl. G06F 21/60; G06F 17/22

(52) U.S. Cl. CPC G06F 21/604; G06F 17/2235

(57) ABSTRACT

The present invention provides for an automated means for validating evidence required in a change process associated with authorized data sources. The automated means is configured to provide a user indication of the progress towards acceptable completion of each phase of the evidence validation process.

### FIELD

In general, embodiments of the invention relate to authorized data sources and, more particularly, systems and the like for validating evidence required in change processes associated with authorized data sources.

### BACKGROUND

In a large enterprise environment many data sources may exist, some of which are deemed as authorized data sources based on the provable authenticity of the data sources and the data associated therewith, as well as, the security requirements surrounding the data sources. In many instances, the basis for authorized data sources are government-mandated regulatory compliance standard that the enterprise is required to meet.

In instances in which a change process occurs that is associated with the authorized data source there is a need to insure that evidence exists and can be validated to support the requirements of the change process. A change process, as it pertains to authorized data sources, may include new data, or new data attributes, that are required to be stored in the authorized data source, which would require evidence and subsequent validation of the evidence for purposes of assuring that the change process meets any government-mandated regulatory compliance standard.

Since each of the authorized data sources may have specific requirements in terms of the evidence required of a change process (i.e., the requirements associated with a government-mandated regulatory compliance standard may differ from data source to another), the validation of such evidence can become a complex task, wrought with inefficiencies and the potential for inconsistencies.

Therefore, a need exists to streamline and automate the process for validation of evidence in change processes associated with authorized data sources.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like for automating and adding consistency to the process for validating evidence required of change processes associated with authorized data sources. As previously discussed, authorized data sources are those data sources (i.e., physical storage device, data repositories, databases and the like) that have been proven, through evidentiary procedures and the like, to meet requisite internal or external standards, such as, but not limited to, government-mandated regulatory compliance standards. Any changes that occur to such authorized data sources, such as adding new data or new data attributes, requires the production of evidence and validation of the evidence to make sure that the change complies with the internal and/or external standards. In addition, a change process, as used herein may include, in certain embodiments, the addition of a new authorized data source or the like.

The present invention provides an evidence validating entity (also referred to a user/respondent) a systematic and consistent approach for validating evidence through presentation of a series of authorized data source-specific queries that are directly related to the requirements of the internal and/or external standards. Moreover, as the respondent provides inputs to the queries, a validation of evidence score is presented and updated, in real-time, to reflect the current status of the successful completion of validation of evidence process. As such, the respondent has immediate feedback as to any actions that may be required in order to successfully complete the validation of evidence process. In additional embodiments, the validation of evidence of process is segmented into a plurality of phases, such that the phases align development stages of the change process (e.g., define, analyze, improve, control and the like). In such embodiments of the invention successful completion and approval of one phase is required in order for the user/respondent to move to the next phase of evidence validation.

An apparatus for validating evidence required in a change process associated with one of a plurality of authorized data sources defines first embodiments of the invention. The apparatus includes a computing platform having a memory and at least one processor in communication with the memory. Further, the apparatus includes a validation of evidence module that is stored in the memory and executable by the processor. The validation of evidence module is configured to provide a plurality of user-interfaces that each present a series of queries to a respondent, wherein each of the queries are associated with a corresponding evidence requirement specific to the authorized data source. In addition, the module is configured to receive an input from the respondent that replies to a corresponding query, and, in response to receiving the input, present in a corresponding user-interface a validation of evidence score that is updated, in real-time based on the input, to reflect a current status of acceptable completion of at least a portion of a validation of evidence process.

In specific embodiments of the apparatus, the validation of evidence module is further configured to provide the plurality of user-interfaces, wherein each user-interface is related to a one of a plurality of phases of the change process. For example, a define/analysis phase, an improve/test phase, a control phase or the like. In such embodiments of the apparatus, the validation of evidence module is further configured to present in the corresponding user-interface the validation of evidence score that is specific to the phase of the change process and is updated, in real-time based on the input, to reflect a current status of acceptable completion of the phase of the validation of evidence process. In such embodiments of the apparatus, the module may be configured such that a predetermined validation of evidence score is required to be met in order for the acceptable completion of the phase of the validation of evidence process.

In other specific embodiments of the apparatus, the validation of evidence module is further configured to, in response to receiving the input, present in the corresponding user-interface an indication of a level of acceptable completion of at least a portion of the validation of evidence process, wherein the level of acceptance is based on the validation of evidence score. In such embodiments of the apparatus, the indication is a color-coding within the corresponding user-interface, wherein different colors reflect different levels of acceptable completion of at least a portion of the validation of evidence process.

In other specific embodiments of the apparatus, the validation of evidence module is further configured to provide the plurality of user-interfaces that each present the series of queries, wherein each query has a corresponding link that, when accessed by the respondent, provides access to details (e.g., a checklist of requirements or the like) associated with a corresponding requirement of the authorized data source.

Moreover, in additional embodiments of the apparatus, the validation of evidence module is further configured to receive the input from the respondent that (i) replies to the corresponding query and (ii) provides a hyperlink that allows a user to access data that provides evidence to support the reply to the corresponding query.

A system for validating evidence required in a change process associated with one of a plurality of authorized data sources defines second embodiments of the invention. The system includes a plurality of authorized data sources that receive and store data, such that, the authorized data sources have been authorized based on verified compliance to regulatory standards. In addition, the system includes a validation of evidence module stored this is stored in memory and executable by a processor. The module is configured to provide a plurality of authorized data source-specific user-interfaces that each present a series of queries to a respondent. Each of the queries are associated with a corresponding evidence requirement specific to one of the authorized data sources. The module is further configured to receive an input from the respondent that replies to a corresponding query, and, in response to receiving the input, present in a corresponding user-interface a validation of evidence score that is updated, in real-time based on the input, to reflect a current status of acceptable completion of at least a portion of a validation of evidence process.

In further embodiments of the system the validation of evidence module is further configured to (i) provide the plurality of user-interfaces, wherein each user-interface is related to a one of a plurality of phases of the change process and (ii) present in the corresponding user-interface the validation of evidence score that is specific to the phase of the change process and is updated, in real-time based on the input, to reflect a current status of acceptable completion of the phase of the validation of evidence process.

In other specific embodiments of the system, the validation of evidence module is further configured to, in response to receiving the input, present in the corresponding user-interface an indication of a level of acceptable completion of at least a portion of the validation of evidence process, wherein the level of acceptance is based on the validation of evidence score. In such embodiments of the system, the indication of the level of acceptable completion is a color-coding within the corresponding user-interface, wherein different colors reflect different levels of acceptable completion of at least a portion of the validation of evidence process.

In further specific embodiments the system includes an evidence database that is configured to store data required as evidence for change processes associated with authorized data source. In such embodiments of the system the validation of evidence module is further configured to receive the input from the respondent that (i) replies to the corresponding query and (ii) provides a hyperlink that, upon activation, accesses access the evidence database to present data required as evidence for the change process undergoing evidence validation.

In additional specific embodiments of the system, the validation of evidence module is further configured to provide the plurality of user-interfaces that each present the series of queries, wherein each query has a corresponding link that, when accessed by the respondent, provides access to details associated with a corresponding requirement of the authorized data source.

A computer program product including a non-transitory computer-readable medium defines third embodiments of the invention. The computer-readable medium includes a first set of codes for causing a computer to provide a plurality of user-interfaces that each present a series of queries to a respondent. Each of the queries are associated with a corresponding evidence requirement for a change process associated with an authorized data source. The computer-readable medium includes a second set of codes for causing a computer to receive an input from the respondent that replies to a corresponding query, In addition, the computer-readable medium includes a third set of codes for causing a computer, in response to receiving the input, present in a corresponding user-interface a validation of evidence score that is updated, in real-time based on the input, to reflect a current status of acceptable completion of at least a portion of a validation of evidence process.

Thus, systems, apparatus, methods, and computer program products herein described in detail below provide for automated and consistent validation of evidence required in a change process associated with an authorized data source.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram of a system for validation of evidence for a change process associated with an authorized data source, in accordance with embodiments of the present invention;

FIG. 2 provides a block diagram of an apparatus for validation of evidence for a change process associated with an authorized data source, in accordance with embodiments of the present invention;

FIG. 3 provides a flow diagram of a method for validation of evidence for a change process associated with an authorized data source, in accordance with embodiments of the present invention; and

FIGS. 4-9 are various exemplary user-interfaces of a validation of evidence module used to validate evidence for a change process associated with an authorized data source; in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for automating and adding consistency to the process for validating evidence required of change processes associated with authorized data sources. As previously discussed, authorized data sources are those data sources (i.e., physical storage device, data repositories, databases and the like) that have been proven, through evidentiary procedures and the like, to meet requisite internal or external standards, such as, but not limited to, government-mandated regulatory compliance standards. Any changes that occur to such authorized data sources, such as adding new data or new data attributes, requires the production of evidence and validation of the evidence to make sure that the change complies with the internal and/or external standards. In additional embodiments of the invention, a change process may include the addition of a new authorized data source. In additional embodiments of the invention a change process may include an annual review/validation of evidence supporting the existence of an authorized data source (i.e., absent a change to the data source).

The present invention provides an evidence validating entity (also referred to a user/respondent) a systematic and consistent approach for validating evidence through presentation of a series of authorized data source-specific queries that are directly related to the requirements of the internal and/or external standards. Moreover, as the respondent provides inputs to the queries, a validation of evidence score is presented and updated, in real-time, to reflect the current status of the successful completion of validation of evidence process. As such, the respondent has immediate feedback as to any actions that may be required in order to successfully complete the validation of evidence process. In additional embodiments, the validation of evidence of process is segmented into a plurality of phases, such that the phases align development stages of the change process (e.g., define, analyze, improve, control and the like). In such embodiments of the invention successful completion and approval of one phase is required in order for the user/respondent to move to the next phase of evidence validation.

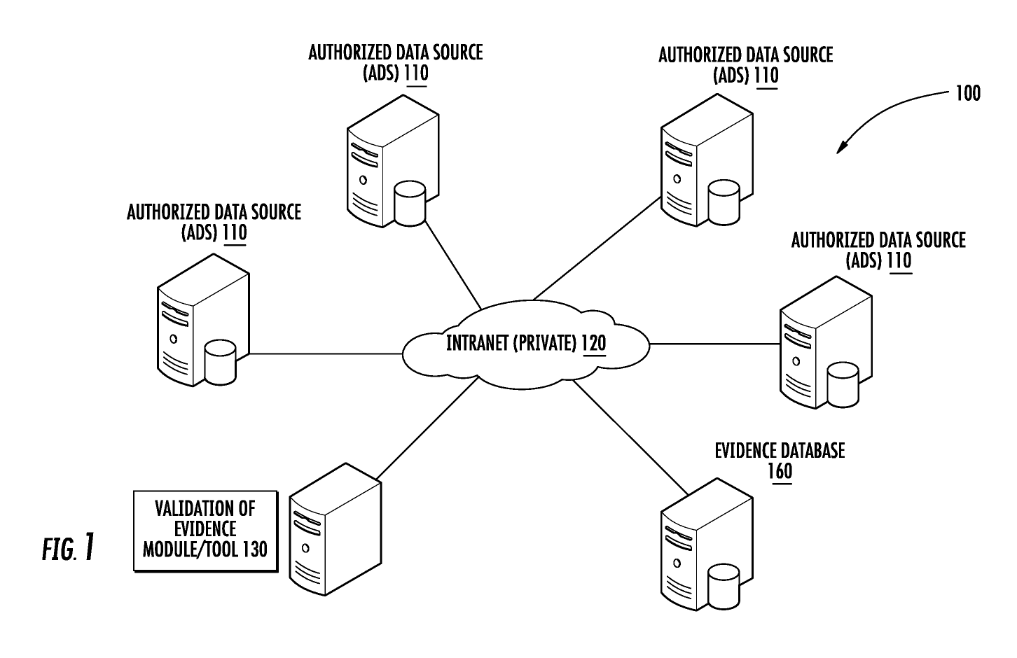

Referring to FIG. 1, a schematic diagram is provided of a system 100 for systematic and automated validation of evidence for a change process associated with an authorized data source, in accordance with embodiments of the present invention. The system 100 comprises a plurality of different authorized data sources 110 disposed throughout a private intranet 120 of an enterprise. Each authorized data source 110 may include one or more apparatus, such as multiple storage servers, data repositories, databases or the like. Each of the authorized data sources may be “authorized” (i.e., accredited, approved, certified or the like) based on different standards. The standards may be standards that are internal to the enterprise and/or external to the enterprise (e.g., government-mandated regulatory standards or the like).

The system 100 additionally a validation of evidence module/tool 130 that may be stored on a server or the like any accessible to users via any computing device that has authorized access to intranet 120. The validation of evidence module/tool 130, which is described in more detail infra., provides for automated consistency in the validation of evidence for change processes associated authorized data sources. In specific embodiments of the invention, the validation of evidence module/tool 130 may be embodied within a spreadsheet application or like and configured to provide a user/respondent a plurality of user-interfaces (i.e., spreadsheets or the like) that each present a series of queries related to a least a portion of the change process associated with the authorized data source. Each of the queries corresponds to internal and/or external requirements placed on the authorized data source, such as government-mandated regulatory compliance requirements or the like. The user/respondent provides inputs that respond to the queries and, in real-time response to receiving the inputs, the validation of evidence module/tool 130 is configured to provide the user/respondent an indication of their current status/progress towards successful completion of the validation of evidence or a specific phase of validation of evidence. The indication may through presentation and updating of a validation of evidence score and/or a visual display within the user-interface (e.g., color-coding or the like) that indicates such current status/progress towards successful completion of at least a portion of the validation of evidence.

Since, as discussed above, each of the authorized data sources will typically have different internal and/or external requirements mandated, in accordance with embodiments of the invention, the validation of evidence module/tool 130 is configured to validate evidence on a specific authorized data source basis. In this regard, the validation of evidence module/tool 130 is configured to provide user-interfaces and, more specifically queries within the user-interfaces that are specific to each of the authorized data sources.

In alternate embodiments of the invention, the system 100 includes an evidence database 160, which allows for capturing and storing key evidentiary documents associated with the change process. Validation of evidence module/tool 130 may be configured to allow for the query respondent/user to provide proof/validation of replies to queries via inclusion in the user interface (e.g., spreadsheet) of a hyperlink that provides access to a specific location within evidence database 160 that stores documents and the like that support/validate the reply provided by the user/respondent.

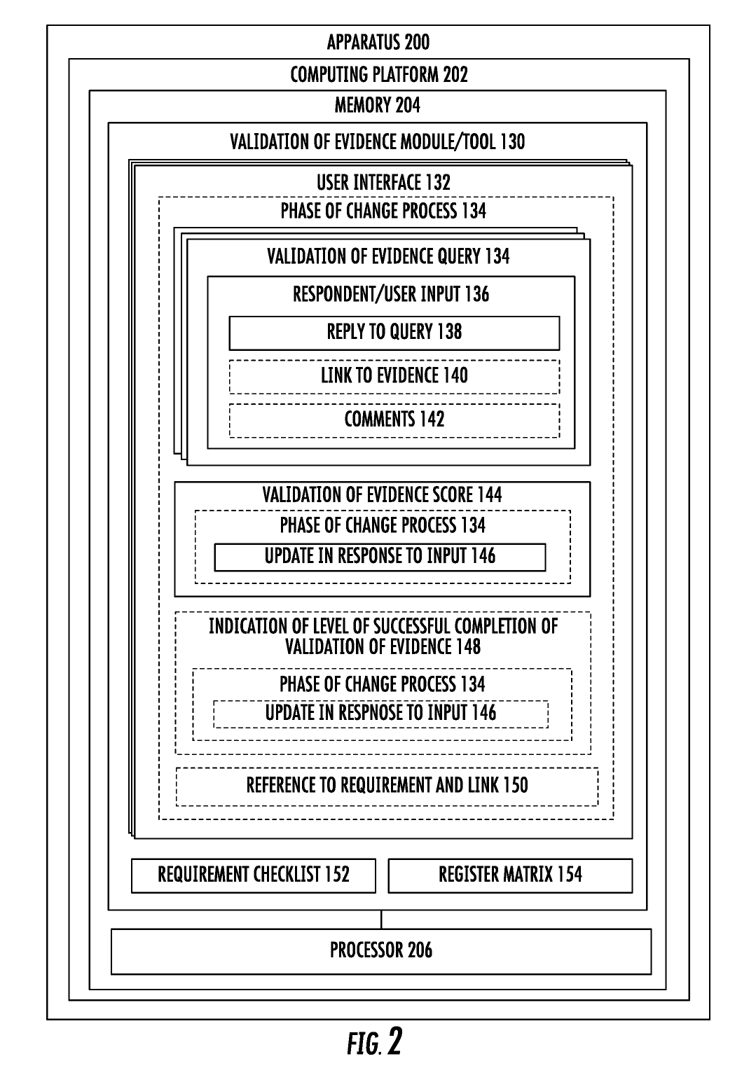

Referring to FIG. 2 a block diagram is depicted of an apparatus 200 configured for validation of evidence in a change process associated with an authorized data source, in accordance with embodiments of the present invention. Apparatus 200 includes a computing platform 202 having a memory 204 and at least one processor 206 in communication with the memory 104. Apparatus 200 may comprise multiple devices, such as multiple servers, storage devices, personal computers and the like.

Memory 204 may comprise volatile and non-volatile memory, such as read-only and/or random-access memory (RAM), read-only memory ROM, EPROM, EEPROM, flash cards, or any memory common to computer platforms. Further, memory 204 may include one or more flash memory cells, or may be any secondary or tertiary storage device, such as magnetic media, optical media, tape, or soft or hard disk. Moreover, memory 204 may comprise cloud storage, such as provided by a cloud storage service and/or a cloud connection service.

Further, processor 206 may be an application-specific integrated circuit (“ASIC”), or other chipset, processor, logic circuit, or other data processing device. Processor 206 or other processor such as ASIC may execute an application programming interface (“API”) (not shown in FIG. 2) that interfaces with any resident programs or modules, such as validation of evidence module 130 and routines, sub-modules associated therewith or the like stored in memory 204 of apparatus 200. Processor 206 includes various processing subsystems (not shown in FIG. 2) embodied in hardware, firmware, software, and combinations thereof, that enable the functionality of apparatus 200 and the operability of the apparatus 200 on a network. For example, processing subsystems allow for initiating and maintaining communications and exchanging data with other networked computing platforms. For the disclosed aspects, processing subsystems of processor 206 may include any subsystem used in conjunction with validation of evidence module 108 and related algorithms, sub-algorithms, modules, sub-modules thereof.

Computer platform 202 may additionally include a communications module (not shown in FIG. 2) embodied in hardware, firmware, software, and combinations thereof, that enables communications among the various components of the computing platform 202, as well as between the other networked devices. Thus, communication analysis module may include the requisite hardware, firmware, software and/or combinations thereof for establishing and maintaining a network communication connection.

Memory 130 stores validation of evidence module/tool 130 previously briefly described in reference to FIG. 1. In accordance with embodiments of the present invention, validation of evidence module 130 is configured to allow for systematical and consistent validation of evidence in a change process associated with an authorized data source.

In specific embodiments of the invention, validation of evidence module 130 is configured to present a plurality of user-interfaces 132 (e.g., a plurality of sheets within a spreadsheet application). In specific embodiments of the invention, each user-interface 134 is specific to a phase 133 of a change process associated with a specific authorized data source. For example, the phases 133 may include but are not limited to define phase; analyze phase; improve/test phase, including system integration testing (SIT) and/or user acceptance testing (UAT); and/or control phase. Each user interface 132 includes a series of validation of evidence queries 134 that are tied to requirements mandated by the internal and/or external compliance standards associated with the specific authorized data source. In those embodiments of the invention in which the user-interfaces 132 are associated with a phase 133, the series of queries 134 are phase-specific.

The validation of evidence module 136 is further configured to receive respondent/user inputs 136 for each of the validation of evidence queries 134 that reply 138 to query 134. In specific embodiments the queries 134 are structured such that the respondent objectively replies 138 to the query in the affirmative, in the negative or that the query is not applicable (i.e., has no impact). In addition, the reply 138 to the query 134, the respondent/user input may include a hyperlink 140 that, upon activation, provides access to evidence to support the reply 138 and/or additional comments 142 that support the reply 138 to the query 134.

Further, the validation of evidence module 136 is configured to, in response to receiving the respondent/user input 136, present in a corresponding user-interface 132 a validation of evidence score 144 that is updated 146, in real-time based on the reply 138 to the query 134, to reflect a current status of acceptable completion of at least a portion of a validation of evidence process. In those embodiments in which the user-interface 132 is associated with a phase 133 of the change process, the validation of evidence score 144 is specific to the phase 133 of the change process undergoing evidence validation.

In specific embodiments of the invention, the validation of evidence module 130 is configured to initially present a highest possible validation of score 144 at the onset of the process, i.e., before the respondent/user has provided any inputs 136 in the form of replies 138 to queries 134. Once the respondent/user replies 138 to a query, the validation of score 144 presented in the user-interface 132 is updated, in real-time, to reflect the score associated with the reply 138. In this regard, if the reply 138 has a positive effect on the validation of evidence process (i.e., validates evidence), the validation of score 144 decreases, and if the reply 138 has a negative effect on the validation of evidence process (i.e., does not validate the evidence), the validation of score 144 decreases. Additionally, if the reply 138 does not have any effect on the validation of evidence process, the validation change 144 may remain unchanged. Once the respondent/user has replied to certain number of queries 134 and/or a certain combination of queries 134, validation of score 144 may approach or reach a score of zero; indicating that the respondent/user has successfully completed the validation of evidence process or, in some embodiments, a particular portion of the validation of evidence associated with a particular phase 133 of the change process. Once the validation of evidence score 144 reaches zero, the validation of evidence data (i.e., the replies 138 to the queries 134) may be saved and the data sent to an approval entity, such as a managing entity associated with the authorized data source, for subsequent approval. It should be noted that in those embodiments in which validation of evidence process is segmented by the phases 133 of the change process, a respondent/user is required to complete and gain approval for validation of evidence of one phase 133 of change process before initiating the validation of evidence for another phase 133 of the change process.

In additional embodiments of the invention, the validation of evidence module 130 is further configured to present and update 146, in real-time response to receiving the reply 138, in the corresponding user-interface 132, an indication of a level of successful completion 148 of at least a portion of the validation of evidence process. In such embodiments of the invention the level of successful completion 148 may be based on the validation of evidence score 144. In those embodiments in which the user-interface 132 is associated with a phase 133 of the change process, the indication of the level of successful completion 148 is specific to the phase 133 of the change process undergoing evidence validation.

In specific embodiments of the invention, the validation of evidence module 130 is configured to present and update the user-interface with the indication of the level of successful completion 148 of the validation of evidence process or a portion of the process associated with a phase, such that the indication is a visual indicator, such as color-coding an area of the user-interface, such as the area including the validation of evidence score 144. In this, regard, different colors may reflect different levels of acceptable completion of at least a portion of the validation of evidence process. For example, the color red may be used to indicate that the validation process is at level at which the validation process cannot be submitted for approval. In the illustrated embodiment described above, in which a highest possible validation of score 144 is presented at the onset of the process, i.e., before the respondent/user has provided any inputs 136 in the form of replies 138 to queries, the area of the user-interface 132 that includes the validation of score 144 may be color-coded red to indicate that the validation process is not ready for approval. The area of the user-interface 132 that includes the validation of score 144 may remain color-coded red until the respondent/user has answered a predetermined number and/or a predetermined combination of the queries 134 correctly (i.e., reply provides for validation of evidence). Once the respondent/user has provided the requisite number of correct replies 138 and/or combination of correct replies 138, the indication of the level of successful completion 148 of the validation of evidence process or a portion of the process may change (e.g., in this instance the color-coding may change from red to green or the like).

In additional embodiments of the invention, the validation of evidence module 130 is configured to provide the user-interfaces which additionally include a reference (e.g., section number or the like) to a requirement 150 in a corresponding requirements document (e.g., a legacy authorized data source checklist or the like) and/or a hyperlink that provides the respondent/user access to the referenced portion of the corresponding requirements document.

Moreover, in other embodiments of the invention, the validation of evidence module 130 is configured to provide for, or provide access to, a legacy requirements checklist 152, which may have been employed as the means for evidence validation prior to the inception of the validation of evidence module 130. In addition, the validation of evidence module 130 may configured to provide for a register matrix 154 that correlates each individual query 138 to a particular reference (e.g., section or the like) within one or more requirements documents, such as a regulatory compliance standard and/or the legacy requirements checklist 152.

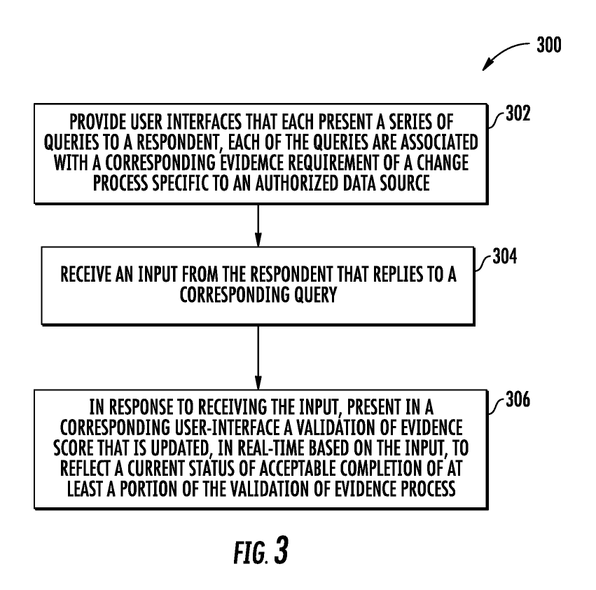

Referring to FIG. 3 a flow diagram is presented of a method 300 for automated validation of evidence in a change process associated with an authorized data source, in accordance with specific embodiments of the present invention. In specific embodiments of the invention, the method 300 herein described may be scheduled to run on a predetermined interval such as annually or, in other embodiments of the invention, the method 300 may implemented in response to a change process associated with an authorized data source (e.g., adding new data and/or data elements to an authorized data source or the like).

At Event 302, a respondent/user is provided users interfaces that each present a series of questions. Each of the queries are associated with a corresponding evidence requirement of a specific authorized data source. In specific embodiments of the invention the evidence requirement is associated with an internal or external compliance standard, such as a government-mandated regulatory compliance standard or the like. In other specific embodiments of the invention each of the user interfaces are associated with a phase of a change process, such as, but not limited to, a define phase, an analysis phase, an improve/test phase, and/or a control phase.

At Event 304 an input is received from the respondent/user that replies to a corresponding query. The reply is configured as an objective reply, such as an affirmative reply, a negative reply or an indication that the query is not applicable for the change process. In alternate embodiments of the method, the input may include additional comments that support the reply and/or a hyperlink that provides a user access to evidentiary documents that support the reply.

At Event 306, in response to receiving the input, present in a corresponding one of the user-interfaces, a validation of evidence score that is updated, in real-time based on the input, to reflect a current status of acceptable completion of at least a portion of the validation process. In those embodiments of the method in which the user-interfaces are specific to a phase of the change process, the validation of evidence score will reflect the current status of acceptable completion of that particular phase of the change process.

As previously discussed in specific embodiments of the invention the validation of evidence score will indicate the highest possible score prior to the respondent/user replying to any of the queries. As the respondent/user replies the validation of evidence score will be updated, in real-time, based on the reply provided. For replies that serve to indicate the occurrence of validation, the validation of evidence score decreases and for replies that serve to indicate that validation has not occurred, the validation of evidence score decreases. In specific embodiments of the method, the goal is for the validation of evidence score to reach a predetermined threshold (e.g., 4) or a predetermined validation of evidence score range (e.g., 0-4), at which the validation of evidence for the change process or the specified phase of the change process is deemed to be acceptable and ready for approval. In other embodiments of the method, an intermediate validation of evidence score range that is higher than the predetermined threshold or range (e.g., 4-8) is defined, at which the validation of evidence or the specified phase of the change process is deemed to questionable in terms of acceptance but may be submitted for approval. In such instances the approval entity may decide to approve the validation of evidence process or phase of the change process or the approval entity may decide that further remedial actions must be taken to resolve outstanding issues related to the validation of evidence.

In other embodiment of the invention, the user-interfaces are configured to present an indication of a level of successful completion of the validation of evidence process or the validation of evidence of a phase of the change process. The indication of the level may take the form of a visual indicator, such as color-coding the area associated with the validation of evidence score. For example, if the validation of evidence score is currently at or above a predetermined threshold (e.g., 10 of higher), the area may be color-coded red or some other color/visual indicator to indicate that the validation process is not at an acceptable level at which submission for approval can occur (i.e., either more queries are required to be answered and/or more queries are required to answered correctly, so as to indicate validation of evidence). In additional example, if the validation of evidence score is currently residing in an intermediate level range that is below the previously mentioned predetermined threshold (e.g., 9-4 or the like), the area may be color-coded yellow or some other color/visual indicator to indicate that the validation process, while not at an fully acceptable level, can be submitted for approval. Further, if the validation of evidence score is currently at or below a predetermined threshold (e.g., 4), the area may be color-coded green or some other color/visual indicator to indicate that the validation process is at a fully acceptable level and that submission for approval is required.

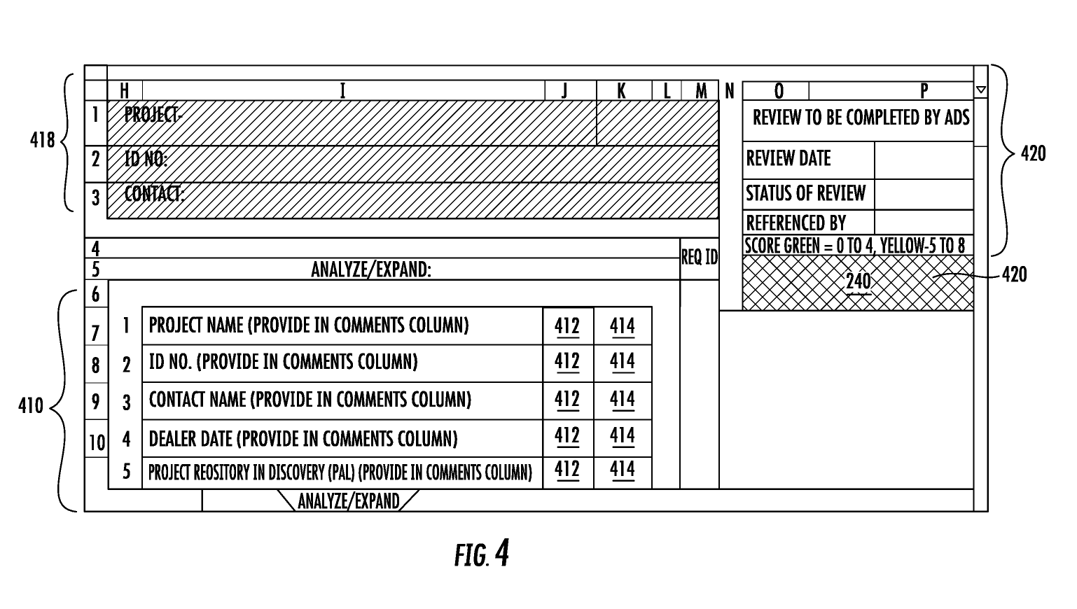

FIGS. 4-9 provide for exemplary user-interfaces (i.e., spreadsheets or the like) and other information/data provided for by a validation of evidence module/tool, in accordance with embodiments of the present invention. The user-interfaces shown in FIGS. 4-8 are by way of example only and should not be construed as limiting. In this regard, other user-interfaces configured differently than those shown in FIGS. 4-8 may be implemented without departing from the inventive concepts herein disclosed.

Referring to FIG. 4, a user-interface 400 (e.g., spreadsheet or the like) is depicted that is illustrative of an initial user-interface provided to a respondent/user upon accessing the validation of evidence module, in accordance with embodiment of the present invention. The analyze/expand tab at the bottom of the user-interface 400 has been engaged to present a series of queries 410. Analyze/expand is the initial phase of the change process and the respondent/user is tasked with completing the analyze/expand phase before moving to the next phase of the change process (i.e., user acceptance test readiness phase). While the user-interface 400 shown in FIG. 4 includes five (5) queries 410, the user-interface 400 is typically configured as scrollable to allow for presentation of more queries, with the number of queries dependent upon the number of requirements/deliverables associated with the corresponding compliance standard. The user-interface 400 additional includes response input fields 412, which may be highlighted (e.g., color-coded or the like) to indicate that a mandatory response is required for the associated query 410. In specific embodiments of the invention, the response input fields 412 may comprise drop-down menus having selections including “yes”, “no” and “not applicable”. In addition, user-interface 400 includes comments input fields 414. One or more of the queries 410 may request specific information be provided in the comment input field 412, such as name, project identification number, project contact name or the like. In addition, respondent/user may input a hyperlink in the comment input field 412 that provides network access to evidentiary data that supports/validates the respondent's reply to the associated query 410.

In addition, user-interface 400 includes presentation of validation of evidence score within a predefined area 416. As previously discussed, in specific embodiments of the invention the initial validation of evidence score, prior to the respondent/user replying to any queries, is the maximum possible validation of evidence score; in this example the score is “240”. Moreover, in specific embodiments of the invention, the predefined area 416 is highlighted (e.g., color-coded) to indicate the current level of acceptable completion of the validation of evidence process for the phase (i.e., the analyze/expand phase) of the change process. In specific embodiments of the invention the level of acceptable completion is associated with a validation of evidence score 240 or a range of validation of evidence scores. In the illustrated example, the predefined area 240 may be color-coded red to indicate that the respondent/user has not yet successfully replied to a predetermined number of queries and/or a predetermined combination of queries and, as such, the respondent/user is not allowed to submit the validation of evidence for approval.

Additionally, user-interface 418 includes general change process information fields 418, such as project name, project identification number and project contact name. In specific embodiments of the invention, the information fields 418 are pre-populated in response to the respondent/user replying to queries 410 that request such information. In addition, approval fields 420 are provided in user-interface 100. The approval fields 420, which includes fields for approval/review data, status of review (e.g., approved, disapproved, and the like) and reviewer name, are completed by a review once the respondent/user has successfully completed the validation of evidence process for the specified phase and, as a result, submitted the validation of evidence process to a pre-assigned approval/review entity for approval/review.

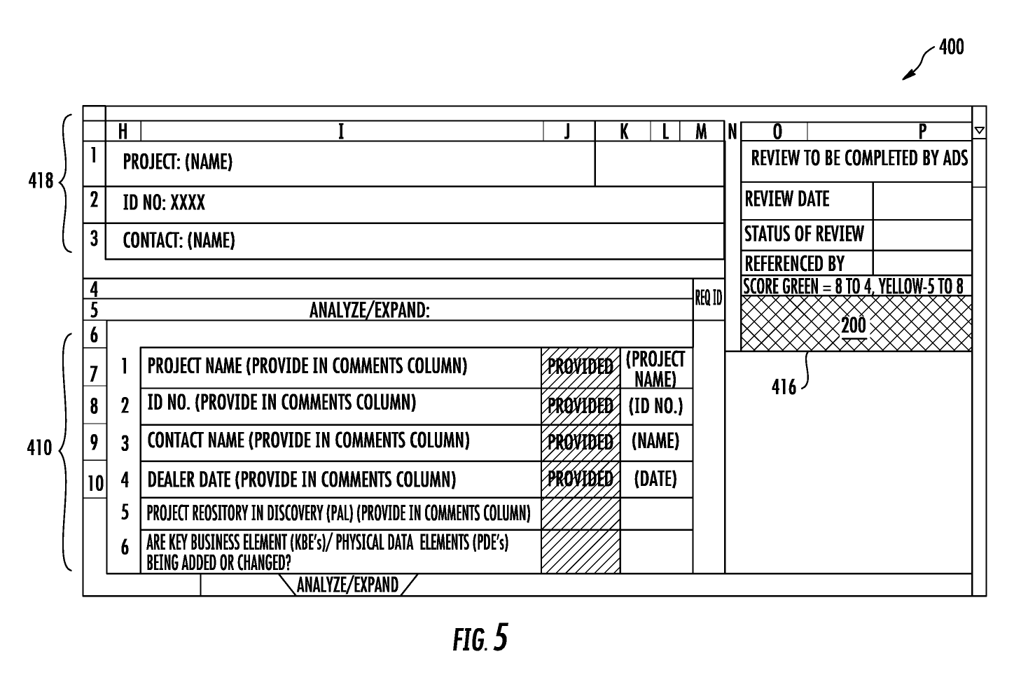

FIG. 5 shows user-interface 400 after a respondent/user has provided inputs to first four (4) queries. The first four (4) queries require the respondent/user to input the requisite information in the comments fields 414. Additional, the first three (3) queries correspond to information in the information fields 418. Thus, in response to the respondent/user inputting the information in the comments 414, the corresponding information is pre-populated in the information fields 418. In addition, since the respondent/user has successfully replied to the first four (4) queries the validation of evidence score presented in the predefined area 416 has decreased, from the initial score of “240” (shown in FIG. 4) to a current validation of evidence score of “200”. However, the indication of the level of acceptable completion has remained the since, since the respondent/user has not yet successfully replied to a predetermined number of queries and/or a predetermined combination of queries and, as such, the respondent/user is not allowed to submit the validation of evidence for approval

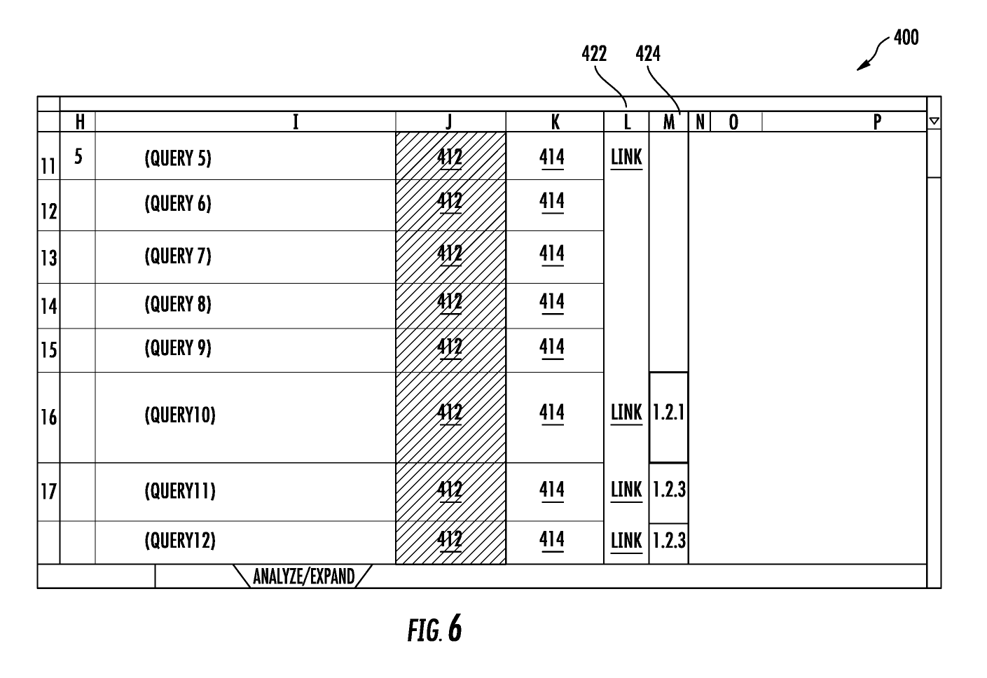

FIG. 6 depicts user-interface 400, which has been scrolled to allow for presentation of additional queries 418 (e.g. Queries Nos. 5-12). Additionally, the user interface 400 includes a hyperlink column 422 that provides for a presentation of a hyperlink that corresponds to additional instructions for certain queries 410, in the event, that the brief query 410 presented in user-interface 400 is insufficient. Moreover, for those queries 410 that are related to specific requirements/deliverables of the compliance standard, the user-interface 400 includes reference column 424 that provides for listing the section number or the like for the corresponding section of the legacy authorized data source checklist. In specific embodiments of the invention, the section number or the like may be hyperlinked to allow the respondent/user to access the corresponding section or the like of the legacy authorized data source checklist.

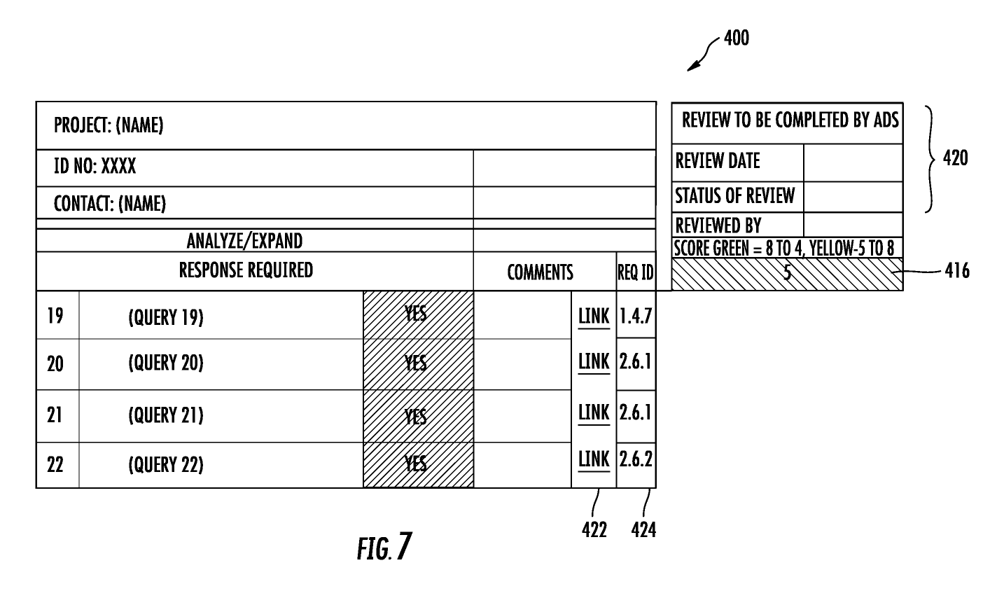

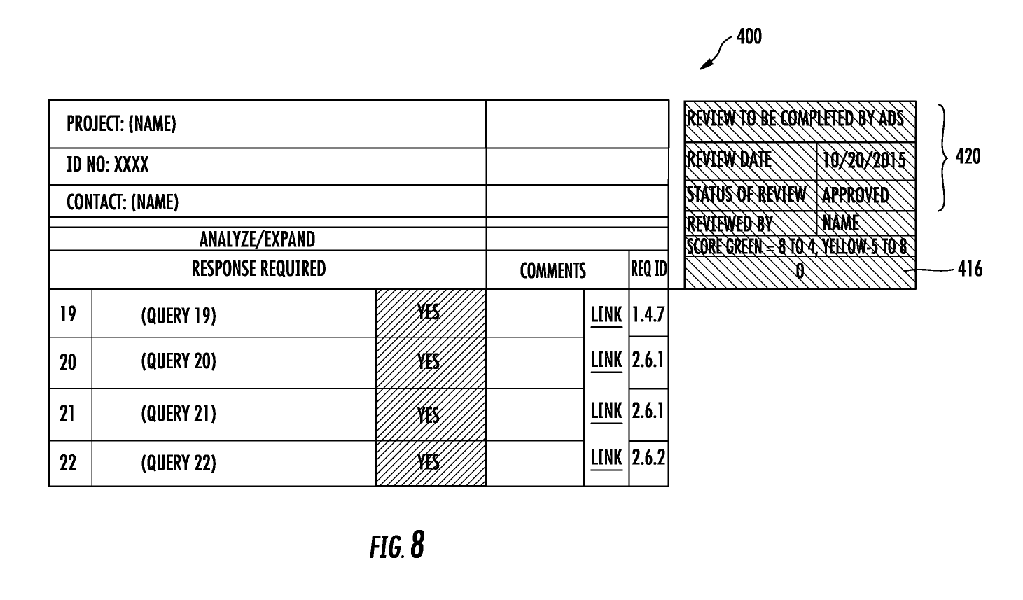

FIG. 7 depicts user-interface 400 in which the respondent user has provided additional inputs as replies to queries 410. In the illustrated embodiment shown in FIG. 8 the respondent's reply to Query No. 22 as “no” indicates that the requirement associated with this query has yet to be met or will not be met. In such instances, the respondent/user will typically provide dialog in comments filed 414 indicating the reason behind why the requirements has yet to be or will not be met. In the illustrated example, the “no” reply to Query No. 22 has resulted in the validation of evidence score of “5”, which in the illustrated example places the score in an intermediate level of acceptable completion of the phase of the change process. In such embodiments of the invention, the predefined area 416 that includes the validation of evidence score may be color-coded “yellow” to indicate the intermediate level of acceptable completion. The intermediate level of acceptable completion, which in the illustrated example is defined by a validation of evidence score between 5 and 9, means that the respondent/user may submit the validation of evidence process for that particular phase of the change process to the approval entity; however, the approval entity will have discretion to accept the exposure associated with the failure to comply to the requirement or to require that the respondent or someone else remediate/resolve the issues so that the requirement is met (i.e., the query can be replied to in the affirmative).

FIG. 8 depicts user-interface 400 in which the respondent user has provided additional inputs as replies to queries 410. In the illustrated embodiment shown in FIG. 8 the respondent's reply to Query No. 22 as “yes” indicates that the requirement associated with this query has been. In the illustrated example, the “yes” reply to Query No. 22 has resulted in the validation of evidence score of “0”, which in the illustrated example places the score in an acceptable level of completion of the phase of the change process. In such embodiments of the invention, the predefined area 416 that includes the validation of evidence score may be color-coded “green” to indicate the acceptable level of acceptable completion. The acceptable level of completion, which in the illustrated example is defined by a validation of evidence score between 4 and 0, means that the respondent/user may submit the validation of evidence process for that particular phase of the change process to the approval entity and that the approval entity will likely approve the validation of evidence process in due course. In the illustrated example of FIG. 8 the validation of evidence process for the analysis/expand has been submitted for approved and approved, as evident by the inputs to the approval fields 420 (approval data, status of approval: approved and name of approval entity) and the highlighting of the approval fields 420 (e.g., color-coding the approval fields 420 “green”).

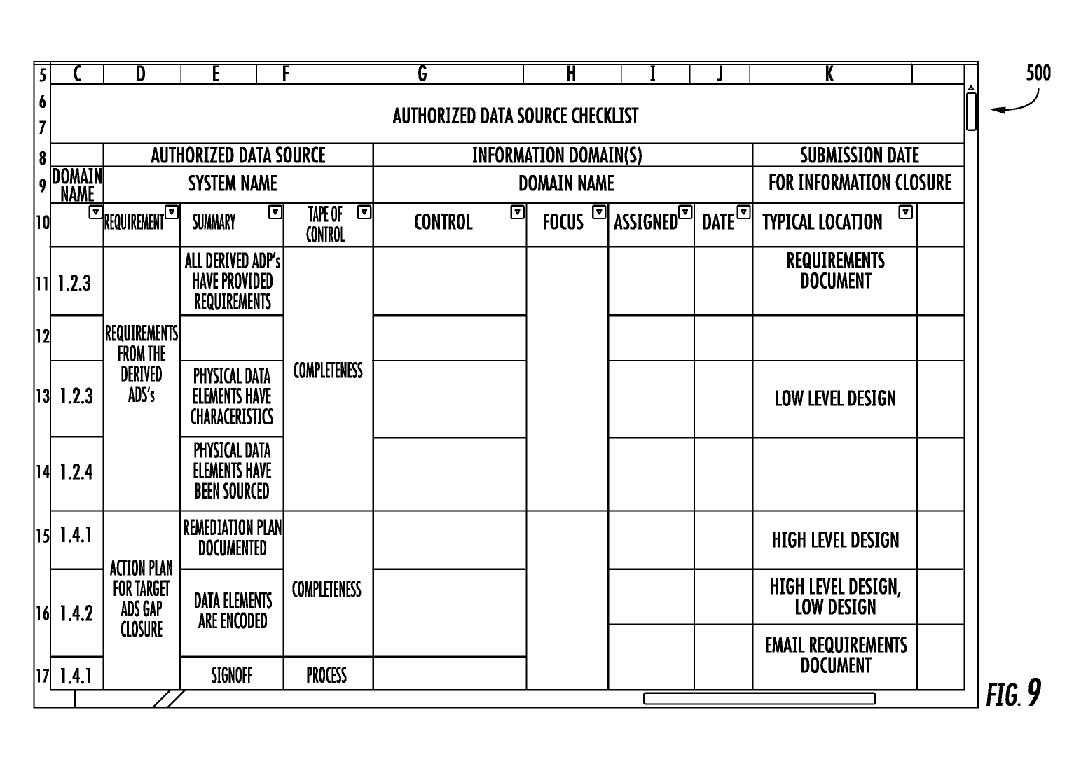

FIG. 9 depicts a legacy authorized data source checklist 500 accessible via tab in the validation of evidence module; in accordance with embodiments of the present invention. The checklist.

Thus, systems, apparatus, methods, and computer program products described above provide for automated, efficient and consistent validation of evidence required in a change process associated with an authorized data source.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for validating evidence required in a change process associated with one of a plurality of authorized data sources, the apparatus comprising:
a computing platform having a memory and at least one processor in communication with the memory; and
a validation of evidence module stored in the memory, executable by the processor and configured to:
provide a plurality of user-interfaces that each present a series of queries to a respondent, wherein each of the queries are associated with a corresponding evidence requirement specific to the authorized data source;
receive an input from the respondent that replies to a corresponding query; and
in response to receiving the input, present in a corresponding user-interface a validation of evidence score that is updated, in real-time based on the input, to reflect a current status of acceptable completion of at least a portion of a validation of evidence process.

2. The apparatus of claim 1, wherein the validation of evidence module is further configured to provide the plurality of user-interfaces, wherein each user-interface is related to a one of a plurality of phases of the change process.

3. The apparatus of claim 2, wherein the validation of evidence module is further configured to present in the corresponding user-interface the validation of evidence score that is specific to the phase of the change process and is updated, in real-time based on the input, to reflect a current status of acceptable completion of the phase of the validation of evidence process.

4. The apparatus of claim 2, wherein the validation of evidence module is further configured to present in the corresponding user-interface the validation of evidence score that is specific to the phase of the change process and is updated, in real-time based on the input, to reflect a current status of acceptable completion of the phase of the validation of evidence process, wherein a predetermined validation of evidence score is required to be met in order for the acceptable completion of the phase of the validation of evidence process.

5. The apparatus of claim 1, wherein the validation of evidence module is further configured to, in response to receiving the input, present in the corresponding user-interface an indication of a level of acceptable completion of at least a portion of the validation of evidence process, wherein the level of acceptance is based on the validation of evidence score.

6. The apparatus of claim 5, wherein the validation of evidence module is further configured to, in response to receiving the input, present in the corresponding user-interface the indication of the level of acceptable completion, wherein the indication is a color-coding within the corresponding user-interface, wherein different colors reflect different levels of acceptable completion of at least a portion of the validation of evidence process.

7. The apparatus of claim 1, wherein the validation of evidence module is further configured to provide the plurality of user-interfaces that each present the series of queries, wherein each query has a corresponding link that, when accessed by the respondent, provides access to details associated with a corresponding requirement of the authorized data source.

8. The apparatus of claim 1, wherein the validation of evidence module is further configured to receive the input from the respondent that (i) replies to the corresponding query and (ii) provides a hyperlink that allows a user to access data that provides evidence to support the reply to the corresponding query.

9. A system for validating evidence required in a change process associated with one of a plurality of authorized data sources, the system comprising:
a plurality of authorized data sources that receive and store data, wherein the authorized data sources have been authorized based on verified compliance to regulatory standards;
a validation of evidence module stored memory, executable by a processor and configured to:
provide a plurality of authorized data source-specific user-interfaces that each present a series of queries to a respondent, wherein each of the queries are associated with a corresponding evidence requirement specific to one of the authorized data sources;
receive an input from the respondent that replies to a corresponding query; and
in response to receiving the input, present in a corresponding user-interface a validation of evidence score that is updated, in real-time based on the input, to reflect a current status of acceptable completion of at least a portion of a validation of evidence process.

10. The system of claim 9, wherein the validation of evidence module is further configured to (i) provide the plurality of user-interfaces, wherein each user-interface is related to a one of a plurality of phases of the change process, and (ii) present in the corresponding user-interface the validation of evidence score that is specific to the phase of the change process and is updated, in real-time based on the input, to reflect a current status of acceptable completion of the phase of the validation of evidence process.

11. The system of claim 9, wherein the validation of evidence module is further configured to, in response to receiving the input, present in the corresponding user-interface an indication of a level of acceptable completion of at least a portion of the validation of evidence process, wherein the level of acceptance is based on the validation of evidence score.

12. The system of claim 11, wherein the validation of evidence module is further configured to, in response to receiving the input, present in the corresponding user-interface the indication of the level of acceptable completion, wherein the indication is a color-coding within the corresponding user-interface, wherein different colors reflect different levels of acceptable completion of at least a portion of the validation of evidence process.

13. The system of claim 9, further comprising an evidence database that is configured to store data required as evidence for change processes associated with authorized data source, and wherein the validation of evidence module is further configured to receive the input from the respondent that (i) replies to the corresponding query and (ii) provides a hyperlink that, upon activation, accesses the evidence database to present data required as evidence for the change process undergoing evidence validation.

14. The system of claim 9, wherein the validation of evidence module is further configured to provide the plurality of user-interfaces that each present the series of queries, wherein each query has a corresponding link that, when accessed by the respondent, provides access to details associated with a corresponding requirement of the authorized data source.

15. A computer program product including a non-transitory computer-readable medium, the computer-readable medium comprising:
a first set of codes for causing a computer to provide a plurality of user-interfaces that each present a series of queries to a respondent, wherein each of the queries are associated with a corresponding evidence requirement for a change process associated with an authorized data source;
a second set of codes for causing a computer to receive an input from the respondent that replies to a corresponding query; and
a third set of codes for causing a computer, in response to receiving the input, present in a corresponding user-interface a validation of evidence score that is updated, in real-time based on the input, to reflect a current status of acceptable completion of at least a portion of a validation of evidence process.

16. The computer program product of claim 15, wherein the first set of codes is further configured to cause the computer to provide the plurality of user-interfaces, wherein each user-interface is related to a one of a plurality of phases of the change process, and wherein the third set of codes is further configured to present in the corresponding user-interface the validation of evidence score that is specific to the phase of the change process and is updated, in real-time based on the input, to reflect a current status of acceptable completion of the phase of the validation of evidence process.

17. The computer program product of claim 15, wherein the third set of codes is further configured to cause the computer to, in response to receiving the input, present in the corresponding user-interface an indication of a level of acceptable completion of at least a portion of the validation of evidence process, wherein the level of acceptance is based on the validation of evidence score.

18. The computer program product of claim 17, wherein the third set of codes is further configured to cause the computer to validation of evidence module is further configured to, in response to receiving the input, present in the corresponding user-interface the indication of the level of acceptable completion, wherein the indication is a color-coding within the corresponding user-interface, wherein different colors reflect different levels of acceptable completion of at least a portion of the validation of evidence process.

19. The computer program product of claim 15, wherein the second set of codes is further configured to cause the computer to receive the input from the respondent that (i) replies to the corresponding query and (ii) provides a hyperlink that, upon activation, accesses and presents data required as evidence for the change process undergoing evidence validation.

20. The computer program product of claim 15, wherein the first set of codes is further configured to cause the computer to provide the plurality of user-interfaces that each present the series of queries, wherein each query has a corresponding link that, when accessed by the respondent, provides access to details associated with a corresponding requirement of the authorized data source.
